(19) United States
(12) Patent Application Publication
(10) Pub. No.: US 2010/0062298 A1
(43) Pub. Date: Mar. 11, 2010

(54) FUEL CELL AND METHOD OF OPERATING THE SAME

(76) Inventor: Jeroen Valensa, Muskego, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/524,121

(22) PCT Filed: Jan. 31, 2008
(86) PCT No.: PCT/US08/52612

§ 371 Date: Jul. 22, 2009

Related U.S. Application Data
(60) Provisional application No. 60/898,583, filed on Jan. 31, 2007.

(51) Int. Cl. H01M 8/18; H01M 8/04

(52) U.S. Cl. 429/19; 429/26

(57) ABSTRACT

The present invention provides a fuel cell system including a first insulated enclosure enclosing a first interior space maintained at a temperature greater than ambient, a plurality of fuel cells maintained at an elevated temperature so as to maximize efficiency of an electrical current generating reaction, and a second insulated enclosure positioning within the first interior space and enclosing a second interior space. The second interior space can be maintained at a temperature greater than the first interior space and approximately equal to the elevated temperature of the stacks. The system can include non-superalloy metallic elements located in the first insulated enclosure. The temperature of the first interior space can be sufficiently low such that exposure of the non-superalloy metallic elements to one of an oxidizing gas stream and a reducing gas stream does not degrade the non-superalloy metallic elements.

### RELATED APPLICATIONS

This application claims priority to U.S. Provisional Patent Application No. 60/898,583 filed on Jan. 31, 2007.

### FIELD OF THE INVENTION

The present invention relates to fuel cells, and more specifically is directed to the construction and operation of fuel cell systems having solid oxide fuel cells.

### SUMMARY

Solid oxide fuel cells (SOFCs) are solid-state electrochemical devices that use a solid ceramic electrolyte to conduct oxygen ions from an oxidizing gas stream at a cathode end of the fuel cell to a reducing gas stream at the anode end of the fuel cell. The oxidizing flow can be air, while the fuel flow can be a hydrogen-rich gas created by reforming a hydrocarbon fuel source.

The solid oxide fuel cell of the present invention can have a number of different constructions and chemistries, one of which is referred to as a planar solid oxide fuel cell. A planar SOFC can be constructed of a thin electrolyte with a cathode electrode on one surface and an anode electrode on the opposite surface. An interconnect can be used to electrically connect the anode of one fuel cell with the cathode of the adjacent cell in the stack. One set of flow channels in the interconnect can provide the fuel flow with access to the anode, and another set of flow channels in the interconnect can provide the air flow with access to the cathode. A flow manifold can be incorporated within the fuel cell stack in order to isolate the fuel flow from the oxidizing flow, and to evenly distribute the fuel flow to the anodes of the multiple cells in the stack. In some fuel cell designs of the present invention, a similar manifolding structure can be provided to distribute the air flow to the cathodes of the multiple cells in the stack (referred to as an internally manifolded stack), while in other fuel cell designs the cathode flow channels in each individual interconnect can have access to an inlet and an outlet face of the stack in order to provide an entrance and exit for the cathode air flow (referred to as an externally manifolded stack).

The fuel cell, operating at a temperature typically between about 750° C. and about 1000° C., enables the transport of a negatively charged ion (O⁼) from the cathode electrode to the anode electrode, where the ion combines with either free hydrogen or hydrogen in a hydrocarbon molecule to form water vapor, or with carbon monoxide to form carbon dioxide. The excess electrons from the negatively charged ion are routed back to the cathode side of the fuel cell through an electrical circuit completed externally between anode and cathode, resulting in an electrical current flow through the circuit. In some SOFC systems, multiple such cells are placed in an electrical series as one or more fuel cell stacks in order to provide an electrical current at a sufficiently high voltage.

Such a fuel cell system can be used to produce useful electrical power by consumption of common hydrocarbon fuels, such as, for example natural gas, propane, liquified petroleum gas (LPG), gasoline, and diesel. This enables the use of a SOFC system as an alternative to conventional electrical power generation devices such as internal combustion engine based generator sets for use in a distributed power generation (DPG) system or auxiliary power unit (APU). A solid oxide fuel cell based DPG system or APU offers several advantages over traditional generator sets, including eliminating undesirable noise levels inherent in internal combustion engine operation, reducing or eliminating the emission of pollutants such as carbon monoxide, oxides of nitrogen, and unburned hydrocarbons, and providing higher power conversion efficiencies.

There are substantial difficulties encountered in producing solid oxide fuel cell based distributed power generation systems or auxiliary power units at a cost level that is comparable to that of the traditional internal combustion engine based systems. One of the greatest such difficulties lies in producing the balance of plant componentry required for the proper operation of the solid oxide fuel cells. Proper operation of an SOFC system can require several processing steps to be performed, including one or more of the following: the recuperative transfer of thermal energy from the waste gas streams; chemical reforming of the hydrocarbon fuel into a hydrogen and carbon monoxide flow stream with minimal amounts of higher hydrocarbons; water recovery from waste gas streams; structural support of the fuel cell stacks; and combustion of remaining combustible species in the anode exhaust gas stream.

Because the fuel cell stacks themselves operate at an elevated temperature, many of these process operations, as well as the components that serve to deliver the gas streams between the different operations and components, are similarly exposed to elevated temperatures. This requires that the materials of construction for these balance of plant operations be capable of long-term operation while exposed to such temperatures. The materials generally considered to be both capable of long-term exposure to such temperatures and suitable for performing the required process operations are nickel-chromium based metallic “superalloys”, which exhibit advantageous properties such as high temperature creep resistance, long fatigue life, phase stability, and exceptional oxidation and corrosion resistance. The use of such materials, however, dramatically increases the cost of the fuel cell system. More conventional austenitic stainless steels, which have substantially lower nickel content, are available at a cost that is typically less than 10% of the cost of an equal quantity of superalloy material, but the properties of austenitic stainless steels make them unsuitable for use at a metal temperature exceeding approximately 600° C. Many of the balance of plant components have heat exchanger functionality, which requires that a substantial amount of heat transfer surface area and consequently a substantial amount of superalloy material be used. In addition, the conveyance of the fluid flows between the various processing components requires interconnecting piping that is similarly constructed of high temperature capable superalloys, and all of which can be connected using labor-intensive welding operations and/or expensive compression-fitting connections. This further increases the cost of an SOFC system.

In some embodiments, the present invention provides a system and a method for reducing the cost of a solid oxide fuel cell system by, among other things, minimizing the amount of superalloy materials required in the construction of the fuel cell balance of the plant.

In some embodiments, the present invention simplifies the construction of a solid oxide fuel cell system and minimizes the amount of superalloy materials required, thereby reducing the cost of a solid oxide fuel cell based distributed power generation system.

In some embodiments, a fuel cell system includes a first insulated enclosure, the interior of which is maintained at a moderate elevated temperature over the surrounding ambient, the elevated temperature being suitably low to allow for the long-term exposure of austenitic stainless steel materials to both oxidizing and reducing gas streams at that temperature. The first insulated enclosure can contain a second insulated enclosure, the interior of which can be maintained at a temperature approximately equal to the operating temperature of solid oxide fuel cells.

In some embodiments, the first insulated enclosure also contains a structure constructed of austenitic stainless steel or similar materials of construction, which structurally supports the second insulated enclosure and which delivers fuel cell process flows to and receives fuel cell process flows from the second insulated enclosure. In some embodiments, the aforementioned structure enables heat transfer required for proper operation of the fuel cell system between two or more of the fuel cell process flows therein.

In some embodiments, the first insulated enclosure contains additional heat exchange components required for proper operation of the fuel cell system.

In some embodiments, the second insulated enclosure contains a plurality of solid oxide fuel cell stacks. In some embodiments, the second insulated enclosure contains a fuel processing reformer. In some embodiments, the second insulated enclosure contains one or more high temperature heat exchangers. In some embodiments, the second insulated enclosure contains a flow manifold structure that provides structural support for the solid oxide fuel cell stacks and that routes flows to and/or from the solid oxide fuel cell stacks, the fuel processing reformer, and the one or more high temperature heat exchangers.

In some embodiments, the air space inside the first insulated enclosure is filled with a gas comprised of cathode exhaust and combusted anode exhaust. In some embodiments, the gas is continuously vented from the first insulated enclosure and is replaced by more of the same gas from the second insulated enclosure during operation of the fuel cell system.

Other aspects of the invention will become apparent by consideration of the detailed description and accompanying drawings.

### BRIEF DESCRIPTION OF THE DRAWINGS

FIG. 1 is a partial cutaway perspective view of a solid oxide fuel cell system according to some embodiments of the present invention;

FIG. 2A is a schematic partial sectional view depicting certain features of the unit of FIG. 1, with cathode air flow movement within an insulated enclosure depicted;

FIG. 2B is a schematic partial sectional view depicting certain features of the unit of FIG. 1 in a viewing direction perpendicular to that of FIG. 2A, with cathode air flow movement within an insulated enclosure depicted;

FIG. 3A is a sectional view taken from line 3A-3A in FIG. 2B;

FIG. 3B is a sectional view taken from line 3B-3B in FIG. 3A;

FIG. 4 is a perspective view of a manifolding structure and certain other components for use in the unit shown in FIG. 1;

FIGS. 5A and 5B are views similar to FIG. 3A, with FIG. 5A illustrating the flow of the anode feed and exhaust gases and FIG. 5B illustrating the flow of the cathode feed and exhaust gases;

FIG. 5C is a view similar to FIG. 5B depicting an alternate embodiment of the present invention;

FIG. 6 is an enlarged perspective view showing selected portions of the structure shown in FIG. 4;

FIG. 7 is a perspective view of another embodiment of a heat exchange structure for use in the unit shown in FIG. 1;

FIG. 8 is a perspective view of features located on a bottom surface of the manifolding structure shown in FIG. 4;

FIG. 9 is a perspective view of a flow manifolding/heat exchange/structural support feature for use in the unit shown in FIG. 1;

FIG. 10 is a perspective view similar to that of FIG. 9, but with some components removed for clarity;

FIG. 11 is a process flow schematic of a solid oxide fuel cell system embodying the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

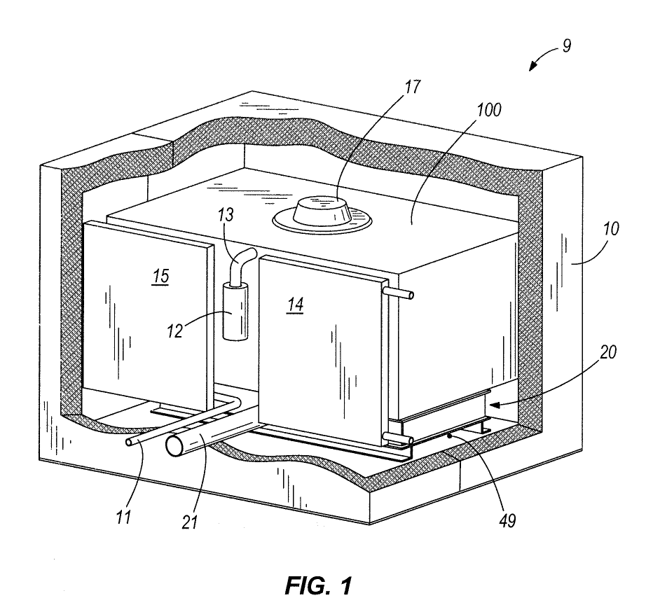

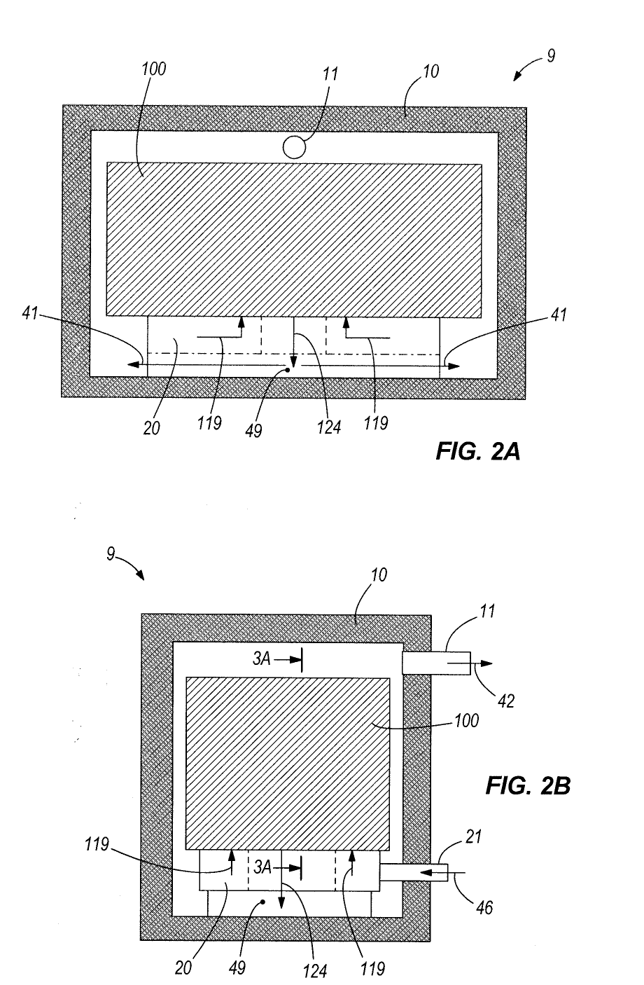

FIGS. 1, 2A and 2B illustrate a high temperature subsystem 9 for use in a fuel cell system based distributed power generation system or auxiliary power unit. The subsystem 9 includes an insulated outer enclosure 10 which contains a hotbox subsystem 100, anode feed injection system 17 and heat exchange/flow manifolding/structural support component 20. In some embodiments, the outer enclosure 10 serves to maintain the environment within at a moderately elevated temperature of approximately 300-450° C. In some embodiments, the insulated outer enclosure 10 also contains additional components, including but not limited to: an anode tailgas oxidation (ATO) reactor 12 connected to the hotbox subsystem 100 with piping 13, an ATO air preheater 14, and a reformer air preheater 15. Other components that may be contained within the insulated outer enclosure 10 are explained in greater detail below.

With reference to FIGS. 2A and 2B, a cathode air stream, shown schematically by arrow 46, enters the heat exchange/flow manifolding/structural support component 20 through inlet pipe 21, which passes through the outer enclosure 10, and is routed into the hotbox subsystem 100 as partially preheated cathode air, shown schematically by arrows 119. An exhaust gas flow, shown schematically by arrow 124, including the cathode exhaust and ATO exhaust is routed from the hotbox subsystem 100 through the heat exchange/flow manifolding/structural support component 20 and into an air space 49 located beneath component 20 and open to the air space within the outer insulated enclosure 10 at either end of component 20, as is illustrated in FIG. 1.

In some embodiments, a water vaporizer heat exchanger 16 is located within the air space 49 to transfer heat from the exhaust flow 124 to a water flow to be used for a reforming process within the hotbox subsystem 100. Exhaust streams, shown schematically by arrows 41, which include the exhaust gas flow 124, exit the air space 49 and fill the cavity within the insulated outer enclosure 10. The insulated outer enclosure 10 is vented through an exhaust pipe 11, located at the upper region of enclosure 10. The location of the exhaust pipe 11 causes the exhaust gas flow 41 to move in a generally upward direction through the enclosure 10. As the exhaust gas flow 41 flows through the enclosure 10, heat is removed from the flow in heat exchangers 14 and 15. The pressure is maintained within the outer enclosure 10 by a flow of exhaust gas, shown schematically by arrow 42, from the enclosure through exhaust piping 11, the exhaust gas flow 42 being comprised of exhaust gas flow 124.

In some embodiments, the outer enclosure is sufficiently sealed so that the exhaust gas flow 42 is removed from the outer enclosure 10 at approximately the same rate as exhaust gas flow 124 enters the space 49. In some embodiments, the exhaust gas flows 124, 41 and 42 are all in a temperature range of 300-450° C.

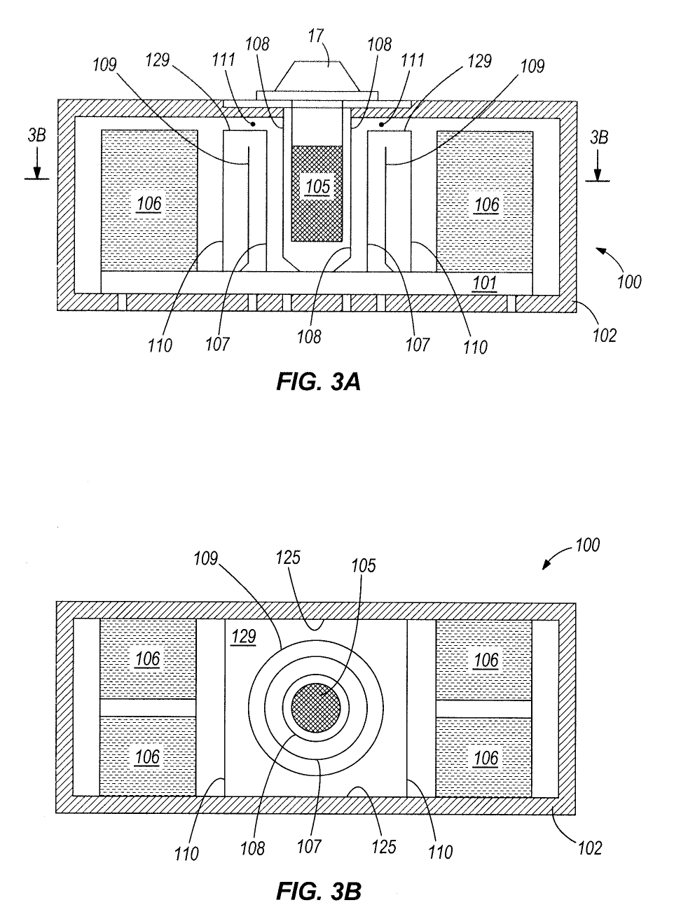

Turning now in greater detail to the hotbox subsystem 100, as best seen in FIGS. 3A and 3B, the hotbox subsystem 100 includes an insulating enclosure 102, a flow manifolding structure 101, a number of solid oxide fuel cell stacks 106, a reformer 105, and a cylindrical cathode recuperator heat exchanger 107. In the illustrated embodiment, the reformer 105 is of a cylindrical monolithic catalytic reactor type and is located at the center of the hotbox subsystem 100. The anode feed injection system 17 is located at the top of the hotbox subassembly 100 in the illustrated embodiment, and is connected to the reformer 105 in such a manner as to allow fluids to flow from the injection system 17 to the reformer 105. A cylinder 108, concentric with and larger in diameter than the cylindrical reformer 105, is provided in order to isolate gas flows in the reformer from the air space inside the enclosure 102. The cylinder 108 extends from the anode feed injection system 17 to the flow manifolding structure 101, and is connected to both the flow manifolding structure 101 and the anode feed injection system 17 in order to prevent the leakage of flow. The connection between cylinder 108 and flow manifolding structure 101 is preferably a metallurgical bond, such as can be achieved by welding or brazing, although other methods of connection may also or alternatively be used. The connection between cylinder 108 and anode feed injection system 17 is can be a serviceable joint, such as, for example, a bolted flange connection with a suitable gasketing material.

In the illustrated embodiment, the cylindrical heat exchanger 107 is larger in diameter than, and located concentric to, cylinder 108, so that a first annular flow passage is created between the inner surface of cylindrical heat exchanger 107 and the outer surface of cylinder 108. The illustrated embodiment can also or alternatively house a cylinder 109 which is larger in diameter than, and located concentric to, cylindrical heat exchanger 108, so that a second annular flow passage is created between the outer surface of cylindrical heat exchanger 107 and the inner surface of cylinder 109.

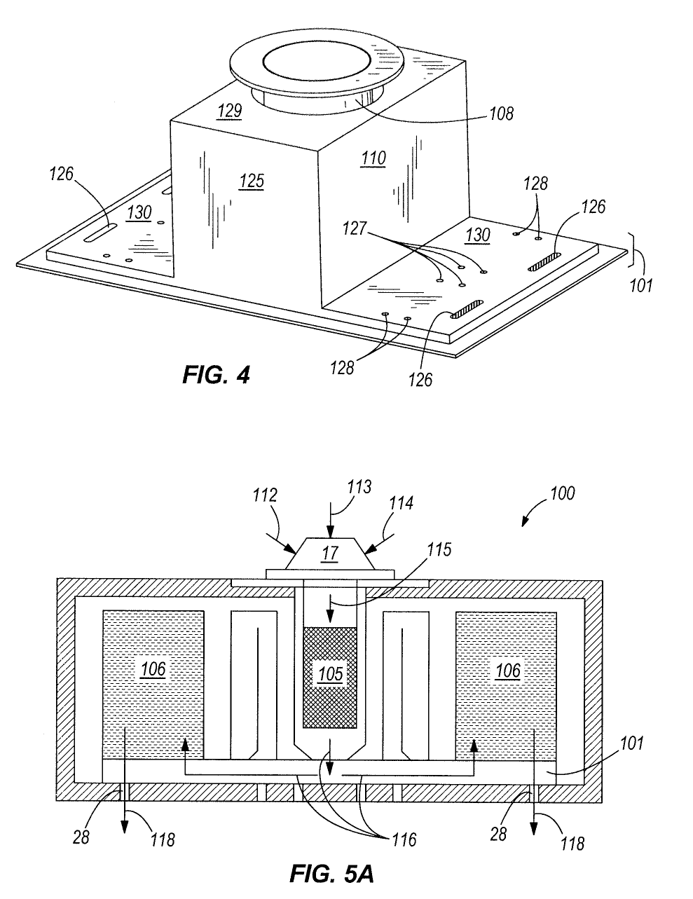

As best seen in FIGS. 3A, 3B, and 4, the illustrated embodiment can also or alternatively include a top plate 129, a first pair of parallel side walls 110, and a second pair of parallel side walls 125 oriented perpendicular to the first pair of side walls 110. The first pair of side walls 110, second pair of side walls 125, top plate 129, cylindrical heat exchanger 107 and manifolding structure 101 are connected by a method, such as, for example, welding and/or brazing, so that a gas flow in the aforementioned first annular flow passage and a gas flow in the aforementioned second annular flow passage are kept isolated from one another.

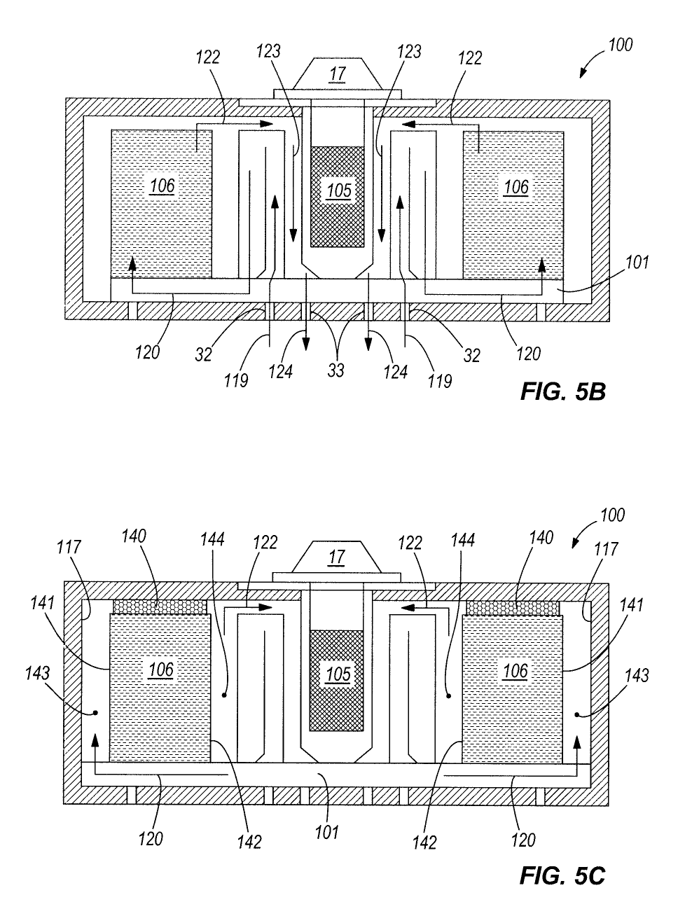

With reference to FIG. 5A, a hydrocarbon fuel flow, shown schematically by arrow 113, a reformer air flow, shown schematically by arrow 112, and steam flow, shown schematically by arrow 114, are delivered through separate plumbing lines (not shown) to the anode feed injection system 17. In some embodiments, the hydrocarbon fuel flow 113 is a vapor. In other embodiments, the hydrocarbon fuel flow 113 is a liquid hydrocarbon and the anode feed injection system 17 is of a design capable of atomizing the fuel flow, including but not limited to a gas-assisted injector, multipoint impingement injector, piezoelectric injector, or other type of injector known to those skilled in the art of liquid fuel injection. The flow streams 112, 113, and 114 together comprise a reformer feed stream shown schematically by arrow 115. The reformer feed stream 115 passes through the catalytic reformer 105, wherein the hydrocarbon fuel is chemically reformed by catalytic partial oxidation and steam reforming to produce a reformate flow which is comprised primarily of hydrogen (H₂), carbon monoxide (CO), carbon dioxide (C0₂), water vapor (H₂O), and nitrogen (N₂). In some embodiments, the ratios of steam and of oxygen in the supplied air to carbon in the hydrocarbon fuel are regulated in order to provide a desired balance between the exothermic catalytic partial oxidation reaction and the endothermic steam reforming reaction, so that the temperature of the reformate exiting the catalytic reformer 105 is kept within a desired temperature range. As one example of such an embodiment, the hydrocarbon fuel flow 113 may include liquid diesel fuel, the atomic oxygen to carbon molar ratio may be maintained at approximately 1.0, and the steam to carbon molar ratio may be maintained at approximately 0.65. It should be noted that the desired steam to carbon and oxygen to carbon ratios can vary greatly depending on, among other factors, the type of hydrocarbon fuel and the type of catalyst used. Moreover, no limitation to the ranges or ratios of steam to carbon and oxygen to carbon is intended in this disclosure. In certain embodiments, the present invention can be operated without any steam flow to the reformer.

The reformate flow, shown schematically by arrows 116, enters the flow manifolding structure 101 and is distributed through the manifold structure to the fuel cell stacks 106. The reformate flow 116 enters anode inlet manifolds internal to the fuel cell stacks 106, wherein the reformate flow is distributed to the anode sides of the individual fuel cells that comprise the fuel cell stacks 106. The anode exhaust gas, shown schematically by arrows 118, is returned to the flow manifolding structure 101 by way of anode exit manifolds internal to the fuel cell stacks 106, and is routed within the flow manifolding structure 101 to two anode exhaust ports 28, through which the anode exhaust gas 118 is removed from the hot box subassembly 100.

With reference to FIG. 5B, the partially preheated cathode air 119 enters the hot box subassembly 100 through a plurality of cathode air inlet ports 32 connected to the flow manifolding structure 101. The flow manifolding structure 101 directs the partially preheated cathode air 119 to flow through the previously described second annular flow passage formed by the outer surface of cylindrical heat exchanger 107 and the inner surface of cylinder 109. During operation of the fuel cells, substantial waste heat is generated by internal electrical resistances in the fuel cell stacks. This heat must be removed at a sufficient rate to maintain the stack operating temperature at a desired level. In order to accomplish this cooling, sufficient cathode air must be supplied to the fuel cell stacks 106, and must be preheated to a temperature that is sufficiently high to prevent damage to the stacks due to thermal shock, but low enough to prevent overheating of the stacks. As the air flow 119 flows along the outer surface of cylindrical heat exchanger 107, the air is further preheated to a temperature appropriate for the fuel cells.

Sufficient space is provided between plate 129 and the top edge of cylinder 109 to allow the now fully preheated air flow 120 to return back down to the manifolding structure 101 through a flow area bounded by the outer surface of cylinder 109 and the inside surfaces of walls 110 and 125. As the air flow moves along the walls 110, it accomplishes some portion of the required stack cooling by removing heat that is radiated from the stacks 106 to the walls 110, thereby also preventing distortion of the structure due to a difference in the thermal expansion of walls 110 relative to the other portions of the structure. The cathode air 120 is routed through the flow manifolding structure 101 to the fuel cell stacks 106. As both the cathode air 120 and the reformate 116 move through the manifolding structure 101, thermal energy is exchanged between them so that any temperature differences between the flow streams is reduced, thereby decreasing any thermal stress due to fluid temperature differences experienced by the fuel cell stacks 106.

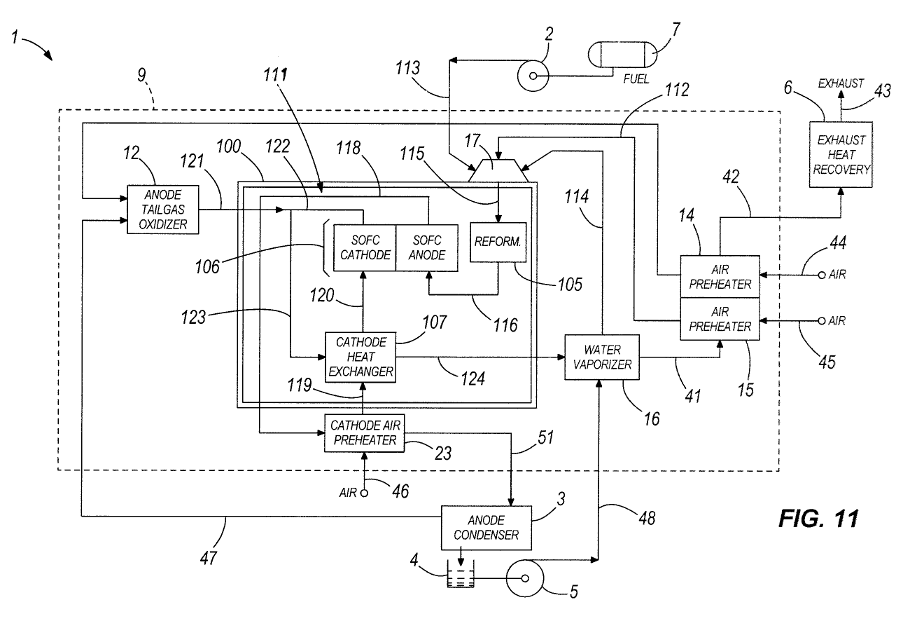

In the embodiment illustrated in FIG. 5B, the fuel cell stacks 106 are of an internally manifolded cathode type. The cathode air 120 is thus routed from the flow manifolding structure 101 to enter the cathode inlet manifolds internal to the fuel cell stacks 106, which distribute the cathode air to the cathode sides of the individual fuel cells that comprise the fuel cell stacks 106. The cathode exhaust, shown schematically by arrows 122, is removed from the cathode exit manifolds internal to the fuel cell stacks 106 at the top portions of the stacks, where it enters the air space inside of the insulated enclosure 102. The cathode exhaust 122 and ATO exhaust flow 121 (FIG. 11) are combined in a mixing region 111, best seen in FIG. 3A, located between the plate 129 and the insulated enclosure 102, to comprise an exhaust gas flow shown schematically by arrows 123. The exhaust gas 123 flows through the previously described first annular flow passage formed by the inner surface of cylindrical heat exchanger 107 and the outer surface of cylinder 108, wherein heat is convectively transferred to the cathode air 119 through the cylindrical heat exchanger 107. The cooled exhaust gas, shown schematically by arrows 124, is removed from the hotbox subassembly 100 through a plurality of exhaust ports 33 that are connected to the flow manifolding structure 101 and pass through the insulated enclosure 102.

In another embodiment illustrated in FIG. 5C, the fuel cell stacks 106 are of an externally manifolded cathode type. In externally manifolded cathode fuel cells, the passages that deliver air to the cathodes of the individual fuel cells that comprise the fuel cell stack are all open to an inlet face of the stack and an opposite exit face of the stack. In this embodiment, a plurality of additional blocks 140 of ceramic or similar material are used to create an inlet air plenum 143 between stack inlet faces 141 and the inside end wall 117 of insulated enclosure 102 at either end of the hotbox subassembly 100. Cathode air 120 enters the air inlet plenums 143 from the flow manifolding structure 101, and flows through the cathode channels in the fuel cell stacks 106. The cathode exhaust 122 exits the fuel cell stacks 106 and discharges into an exit plenum 144 between stack exit faces 142 and walls 110 at either end of the hotbox subassembly 100, from where the cathode exhaust gas 122 is able to flow into the mixing region 111.

It should be appreciated that while it is desirable to minimize the amount of air leakage from the insulated enclosure 102, an advantage of the present invention is that a small amount of air leakage from the insulated enclosure 102 is tolerable since the inner insulated enclosure 102 is contained within the outer insulated enclosure 10. This minimizes the extent to which the inner enclosure 102 needs to be of a welded or equivalently sealed construction, thereby allowing for a lower cost of construction. It should further be appreciated that the structure as described minimizes the number of fluid connections that must be made, and allows for a thermally unconstrained design that obviates the need for thermal expansion bellows or similar features, thereby reducing the overall system cost.

Turning now in greater detail to the construction of the flow manifolding structure 101, as best seen in FIG. 4 in the illustrated embodiment, the flow manifolding structure 101 includes a pair of stack mounting surfaces 130 upon which the fuel cell stacks 106 are supported. Each of the stack mounting surfaces 130 have one or more anode feed exit ports 127, whereby the anode feed 116 is delivered from the flow manifolding structure 101 into the anode inlet manifolds internal to the fuel cell stacks 106, and one or more anode exhaust inlet ports 128, whereby the anode exhaust 118 is delivered from the anode exhaust manifolds internal to the fuel cell stacks 106 into the flow manifolding structure 101. It should be appreciated that while two exit ports 128 and two inlet ports 127 are depicted for each fuel cell stack 106, the number of such ports can be more than two or less than two, depending on the construction details of the fuel cell stacks. It should further be appreciated that the locations of the ports 128 and 127 can be at any location within the footprint of the fuel cell stacks 106. In the illustrated embodiment, each of the stack mounting surfaces 130 of the flow manifolding structure 101 further includes one or more cathode air exits 126, whereby the cathode air 120 is delivered from the flow manifolding structure 101 into the cathode inlet manifolds internal to the fuel cell stacks 106 or externally manifolded fuel cell cathode air inlet plenums 143.

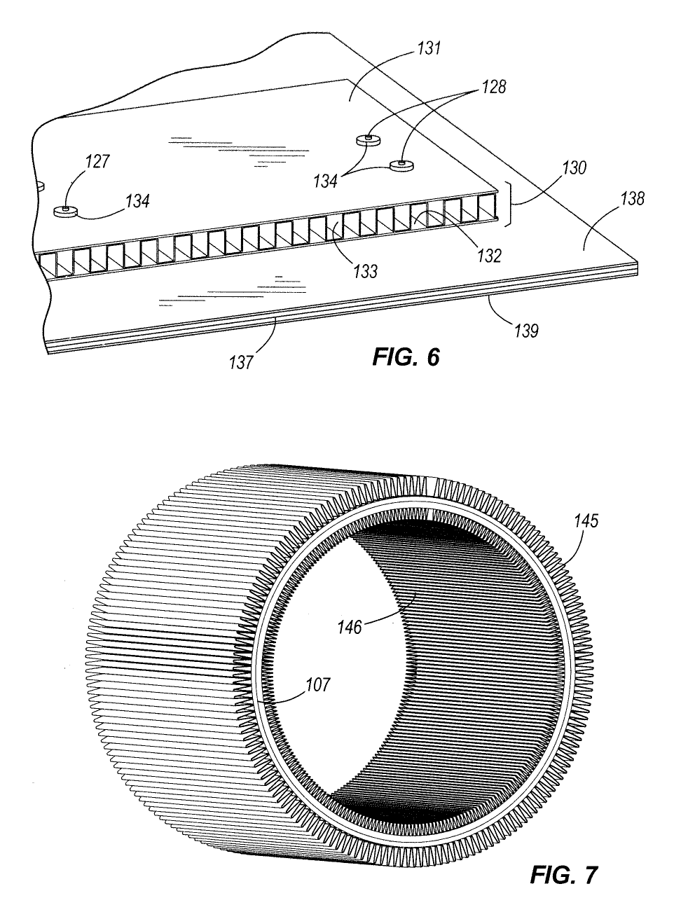

With reference to FIG. 6, which shows some aspects of the construction of the flow manifolding structure 101 depicted in FIG. 4 in greater detail, the flow manifolding structure 101 includes a laminated plate assembly 137 through which the anode flows 116 and 118 are routed on internal layers, the internal passages being capped by a top plate 138 of the laminated plate assembly 137, and a bottom plate 139 of the laminated plate assembly 137. In some embodiments, the laminated plate assembly 137 is fabricated as a leak-free structure by a nickel vacuum brazing process. The manifolding structure 101 is further comprised of a porous cathode air flow structure 130 that allows for the passage of the cathode air 120 with minimal pressure drop while simultaneously providing structural support for the fuel cell stacks 106. In the embodiment illustrated in FIG. 6, the porous cathode air flow structure 130 includes a corrugated metal fin structure 133 with a top plate 131 and a bottom plate 132 metallurgically bonded to either side. The manifolding structure 101 can also or alternatively include a number of tubes 134 that are bonded to the laminated plate assembly 137 and pass through the porous cathode air flow structure 130. The tubes 134 are fluidly connected to the internal passages within the laminated plate assembly 137, and provide the anode feed exit ports 127 and anode exhaust inlet ports 128 for the flow manifolding structure 101.

In some embodiments, heat transfer surface enhancement features are incorporated on one or both sides of the cylindrical heat exchanger 107. FIG. 7 illustrates such an embodiment, with a first convoluted fin structure 146 metallurgically bonded to the inside surface of cylinder 107 to provide enhanced convective heat transfer for the exhaust gas 123 flowing there through, and with a second convoluted fin structure 145 metallurgically bonded to the outside surface of cylinder 107 to provide enhanced convective heat transfer for the cathode air 119 flowing there through. Although the heat transfer surface enhancement features illustrated in FIG. 7 are of a serpentine plain fin type, it should be appreciated that any variety of heat transfer surface enhancements known to those skilled in the art, such as but not limited to louvered fins, herringbone fins and lanced and offset fins, can also or alternatively be employed.

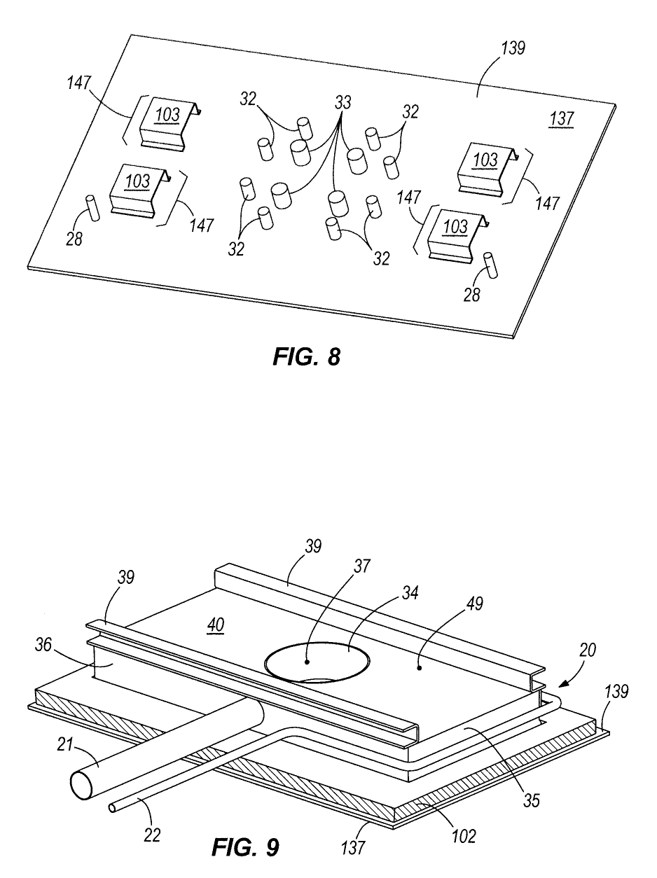

Turning now to the bottom surface of the flow manifolding structure 101, as illustrated in FIG. 8, it can be seen that the bottom plate 139 of the flow manifolding structure 101 contains a number of air inlet ports 32 in a predominantly circular arrangement through which the cathode air 119 enters the hot box subassembly 100, and a plurality of exhaust ports 33 in a predominantly circular arrangement located concentric to and radially inward from the arrangement of air inlet ports 32 through which the exhaust gas 124 exits the hot box subassembly 100. The bottom plate 139 of the flow manifolding structure 101 further contains two anode exhaust ports 28 through which the anode exhaust gas exits the hot box subassembly 100. The bottom plate 139 of the flow manifolding structure 101 further contains a plurality of structural supports 147 formed out of bent sheet metal. In some embodiments, one of the structural supports 147 is located more or less directly beneath each one of the fuel cell stacks 106. It some embodiments, the ports 28, 32, and 33 and the structural supports 147 provide only a minimal pathway for the undesirable conduction of heat out of the high temperature hotbox subassembly 100.

It should be noted that, while the illustrated embodiments show two fuel cell stacks 106 side by side at either end of the hotbox subassembly 100, the invention is not limited in this regard and more or fewer fuel cell stacks can be implemented without affecting the merits of the invention.

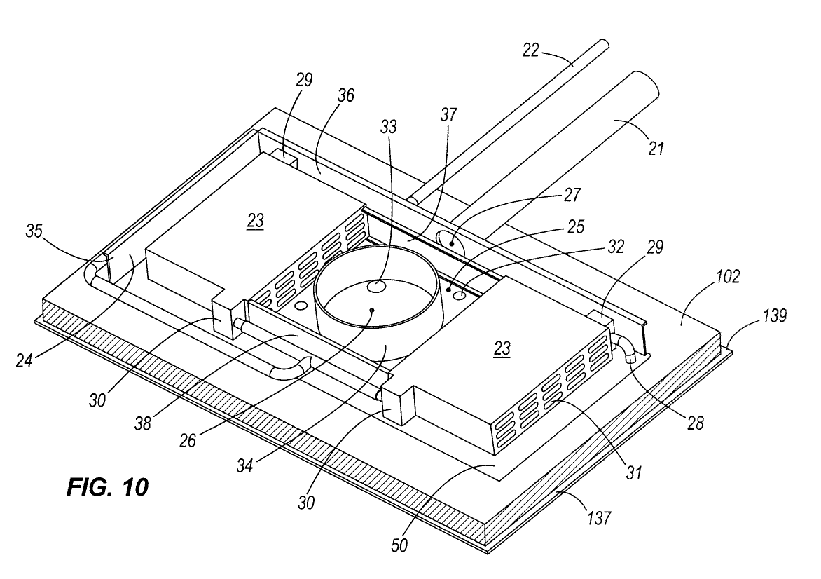

The construction of the heat exchange/flow manifolding/structural support component 20 will now be described in greater detail. Principal aspects of component 20 will be explained with reference to FIGS. 9 and 10, which illustrate the heat exchange/flow manifolding/structural support component 20 along with the laminated plate assembly 137 and the bottom portion of the insulating enclosure 102 in an upside-down orientation consistent with the orientation of FIG. 8. The heat exchange/flow manifolding/structural support component 20 can be formed from austenitic stainless steel construction, and includes a top plate 50, a bottom plate 40, two side walls 36 and two end walls 35. Although not fully illustrated, it should be understood that the top plate 50 is in direct contact with the surfaces 103 of the structural supports 147 illustrated in FIG. 8. The heat exchange/flow manifolding/structural support component 20 can also or alternatively include two support legs 39, which provide the air space 49 below the heat exchange/flow manifolding/structural support component 20. The bottom plate 40 contains a centrally located circular opening 37, through which the exhaust flow 124 enters the air space 49 from a cylindrical plenum 26 bounded by the top plate 50 and a cylindrical wall 34. The plurality of tubes 33 are attached to the top plate 50 in such a manner as to prevent leakage, and allow the exhaust gas flow 124 to enter the cylindrical plenum 26 from the hotbox subassembly 100.

The heat exchange/flow man folding/structural support component 20 contains a pair of cathode air preheater heat exchangers 23 to preheat the cathode air 46 by transferring heat from the anode exhaust gas flow 118. Although it should be understood that the heat exchangers 23 can be of many different types of heat exchanger construction known to those skilled in the art, one embodiment is illustrated in FIG. 10. The illustrated embodiment includes a number of tubes 31 through which the cathode air flow 46 passes. The heat exchange/flow manifolding/structural support component 20 includes an air inlet opening 27 to provide entry of the cathode air flow 46 into the structure 20 from the air inlet pipe 21. The cathode air flow 46 fills an air space 24 around the inside periphery of the structure 20, which distributes the flow 46 to the inlets of the heat exchange tubes 31. The anode exhaust gas flow 118 enters the heat exchange/flow manifolding/structural support component 20 from the hotbox subassembly 100 through the two anode exhaust tubes 28. The two anode exhaust tubes 28 connect to inlet tanks 29 on the two heat exchangers 23 and flow over the outsides of the heat exchange tubes 31, transferring heat to the cathode air 46. The anode exhaust exits the heat exchangers 23 as a cooled anode exhaust flow 51 through exit tanks 30. The cooled anode exhaust flow 51 subsequently flows into the piping 22, which brings the anode exhaust flow 51 out of the heat exchange/flow manifolding/structural support component 20 and out of the high temperature subsystem 9 through the insulating enclosure 10. Although the anode exhaust flow 118 enters the structure 20 at a temperature approximately equal to the temperature of the fuel cell stacks 106, the components 28 and 29 through which the anode exhaust gas flow 118 passes are located directly within the air space 24 through which the cold cathode air 46 passes. As a result, the temperature of components 28, 29 and the other metallic components within the structure 20 which are exposed to the anode exhaust flow 118 can be maintained at a temperature below the acceptable temperature limit for austenitic stainless steel.

In some embodiments, the heat exchangers 23 include heat transfer surface augmentation features attached to the inside surfaces of the heat transfer tubes 31. In these and other embodiments, the heat exchangers 23 can include heat transfer surface augmentation features attached to the outside surfaces of the heat transfer tubes 31.

The heat exchange/flow manifolding/structural support component 20 further contains an air exit plenum 25 comprised of the exit faces of the heat exchangers 23, first and second side walls 37, 38 spanning the distance between the two heat exchangers 23, the top plate 50 and the cylindrical wall 34. The partially preheated cathode air flow 119 flows from the heat exchanger tubes 31 into the air exit plenum 25. The plurality of air inlet ports 32 are attached to the top plate 50 in such manner as to prevent leakage, and provide for a fluid connection to the air exit plenum 25, allowing the partially preheated cathode air flow 119 to exit the heat exchange/flow manifolding/structural support component 20 and enter into the hotbox subassembly 100.

Certain componentry required for operation of the fuel cell system, such as the fluid connections between some of the components within the high temperature subsystem 9 and the electrical buswork that electrically connects the fuel cell stacks to the remainder of the fuel cell system, have not been expressly described within this detailed description and the accompanying drawings, but it should be understood that these and other elements can also or alternatively be included within the high temperature subsystem 9 of one or more embodiments of the present invention. In some embodiments of the invention, all or substantially all of the required fluid and other penetrations through the insulated outer enclosure 10 are located on a common face of the enclosure 10 to facilitate assembly and sealing of the high temperature subsystem 9.

FIG. 11 is a schematic representation of the previously described high temperature subassembly 9 within a fuel cell system 1, and showing the various flows through the high temperature subassembly 9 in relation to each of the major components of the high temperature subassembly 9. FIG. 11 also shows an anode exhaust condenser 3 as an additional component in the fuel cell system 1 that can be employed to condense and remove water vapor formed by the fuel cell anode reactions from the anode exhaust stream 51 exiting the high temperature subassembly 9, after which the now cooled and condensed anode exhaust flow 47 is returned to the high temperature subassembly 9 to be combusted in the anode tailgas oxidizer 12. FIG. 11 also shows a water reservoir 4 to receive the condensed water from the condenser 3, and a water pump 5 to provide a flow of water 48 to the water vaporizer 16 from the water reservoir 4. In a preferred embodiment, the rate at which water is recovered from the condenser 3 exceeds the flow rate at which the water flow 48 is supplied to the vaporizer 16, so that the fuel cell system 1 can be operated in a water-neutral state, that is a state in which a store of makeup water is not required for proper operation of the fuel cell system 1. FIG. 11 also shows an optional fuel tank 7 and fuel pump 2 to provide a fuel flow 113 to the anode feed injection system 17 in the high temperature subsystem 9. Additionally shown in FIG. 11 is an exhaust heat recovery device 6 that receives the exhaust flow 42 from the high temperature subsystem 9 and extracts product heat such as for space heating or other heating use, and produces a fully cooled exhaust flow 43 which is exhausted from the fuel cell system 1.

The embodiments described above and illustrated in the figures are presented by way of example only and are not intended as a limitation upon the concepts and principles of the present invention. As such, it will be appreciated by one having ordinary skill in the art that various changes are possible.

1. A fuel cell system comprising:
a first insulated enclosure substantially enclosing a first interior space maintained at a temperature greater than ambient;
a plurality of fuel cells maintained at an elevated temperature so as to maximize efficiency of an electrical current generating reaction at the fuel cells;
a second insulated enclosure positioned within the first interior space and substantially enclosing a second interior space thermally insulated from the first interior space and additionally the plurality of fuel cell stacks, the second interior space being maintained at a temperature greater than the temperature of the first interior space and approximately equal to the elevated temperature of the fuel cell stacks; and
a plurality of non-superalloy metallic elements located in the first insulated enclosure, the temperature of the first interior space being sufficiently low such that exposure of the non-superalloy metallic elements to at least one of an oxidizing gas stream and a reducing gas stream does not degrade the non-superalloy metallic elements.

2. The fuel cell system of claim 1, wherein at least one of the plurality of non-superalloy metallic elements supports the second insulated enclosure within the first insulated enclosure.

3. The fuel cell system of claim 2, wherein the at least one of the plurality of non-superalloy metallic elements delivers the at least one of an oxidizing gas stream and a reducing gas stream to the plurality of fuel cell stacks.

4. The fuel cell system of claim 1, wherein at least one of the plurality of non-superalloy metallic elements removes a process flows from the fuel cell stacks and directs the process flow outwardly from the first insulated enclosure.

5. The fuel cell system of claim 1, wherein the first insulated enclosure contains a volume of exhaust discharged from the fuel cell stacks.

6. The fuel cell system of claim 5, wherein the first insulated enclosure includes an inlet communicating with the second enclosure to receive the exhaust from the second insulated enclosure and an outlet for venting the exhaust at a rate substantially equal to a rate that the exhaust enters the first enclosure through the inlet so as to maintain a substantially constant pressure within the first insulated enclosure.

7. The fuel cell system of claim 1, wherein, during operation of the fuel cell system, the temperature of the first interior space is between about 300° C. and about 450° C. and the temperature of the second interior space is maintained between about 750° C. and about 1000° C.

8. The fuel cell system of claim 1, further comprising a water vaporizer heat exchanger positioned within the first interior space to transfer heat from exhaust received from the second interior space to a water flow supplied to a reformer supported within the second interior space.

9. The fuel cell system of claim 1, wherein the non-superalloy metallic element is at least partially formed of austenitic stainless steel element.
